(19) United States
(12) Patent Application Publication
(10) Pub. No.: US 2026/0291541 A1
(43) Pub. Date: Sep. 24, 2026

(54) Symbol-Based Control of Passive Intermodulation Cancellation in a Network Node

(71) Applicant: Telefonaktiebolaget LM Ericsson (publ), Stockholm (SE)

(72) Inventors: Emil Sävqvist, Johanneshov (SE); Hengsha Li, Solna (SE); Jin Ellgardt, Sundbyberg (SE); Spendim Dalipi, Sollentuna (SE); Mats Gan Klingberg, Enebyberg (SE)

(21) Appl. No.: 19/134,056

(22) PCT Filed: Dec. 15, 2022
(86) PCT No.: PCT/EP2022/086060

§ 371 Date: May 29, 2025

(51) Int. Cl. H04B 1/525; H04B 1/12

(52) U.S. Cl. CPC H04B 1/525; H04B 1/123

(57) ABSTRACT

There is provided techniques for symbol-based control of PIM cancellation in a network node. A method is performed by a controller. The method comprises obtaining a power indication per each incoming baseband symbol in the network node. The power indication indicates whether each incoming baseband symbol is a zero-power symbol or not. The method comprises providing a deactivation indication to deactivate the PIM cancellation from being performed for any zero-power symbol.

### TECHNICAL FIELD

Embodiments presented herein relate to a method, a controller, a computer program, and a computer program product for symbol-based control of passive intermodulation cancellation in a network node.

### BACKGROUND

In general terms, passive intermodulation (PIM) is a type of distortion generated by nonlinearity of passive components, such as filters, duplexers, connectors, antennas and so forth at a cell site. PIM is thus an intermodulation product that can occur when two or more signals pass through passive components, introducing non-linear distortion to the signals. Depending on the location of the component that generates the PIM, the PIM is categorized as either internal or external. For example, PIM generated by the filters of the transmission (TX) radio chains in the antenna system at the cell site is called internal PIM whereas PIM generated by a metal fence on the roof top of a building, or even rusty bolts, in vicinity of the cell site is called external PIM. Typically, the power level of the PIM component is much lower in magnitude than the signal it originates from. Nevertheless, PIM becomes problematic in a cellular network when strong transmitted signals used for sending information to user equipment interact with the source of the PIM, hereinafter referred to as a PIM source. Interaction with one or more PIM source might cause noise to be introduced in the frequency band used to detect weaker received signals from served user equipment. This distortion of the received signals decreases the reliability, capacity, and data rate of wireless systems.

Different approaches have been proposed for PIM mitigation. In one example, the transmitter power is reduced to effectively lower the PIM level. One drawback is reduced coverage and/or downlink throughput. In another example, expensive high-quality components are used at the TX radio chains. This might reduce internal PIM but will not affect the external PIM. In another example the frequency bands for transmission and/or reception is/are selected from a part of the frequency spectrum with less PIM distortions. This is not always possible as the frequency bands might be licensed and the available frequency spectrum is limited.

Another approach for PIM mitigation is PIM cancellation. PIM cancellation aims to use the transmit signals and receive signals to create a model for the PIM source(s) that are affecting the receive signal. This model is then used to create a replica signal of the PIM signal that impacts the receive signal. The replica signal is then subtracted from the receive signal to obtain a cleaner version of the receive signal. One way to create such a model is by using time domain transmitted signals (e.g., user plane data). In this case, the design problem (i.e., how to create an accurate replica signal) can then be regarded as a time series regression problem. Predicting the PIM in the frequency band for the receive signal is traditionally done with memoryless polynomials. In brief, a set of basis vectors are fit with weights through a least mean square (LMS) criterion, or similar.

Some issues with traditional approaches for PIM cancellation will be disclosed next.

Most of digital PIM cancellation techniques require a comparatively high signal processing capability, and are typically realized by a comparatively large amount of multipliers in a digital circuit, such as in a digital application specific integrated circuit (ASIC). Bit-toggling activity in these multipliers will be high. As a consequence of this, the power consumption of the PIM cancellation part will be high.

It is one desire to keep the power consumption as low as possible. Furthermore, not only is the high power consumption an issue in itself, the high power consumption also causes thermal hot spots. This can be a bottleneck when it comes to cooling, power design, etc. of a piece of radio equipment. In turn, increasing the size of cooling components increases the size and weight of the piece of radio equipment.

Hence, there is still a need for improved PIM cancellation.

### SUMMARY

An object of embodiments herein is to address the above issues with traditional approaches for PIM cancellation.

According to a first aspect there is presented a method for symbol-based control of PIM cancellation in a network node. The method is performed by a controller. The method comprises obtaining a power indication per each incoming baseband symbol in the network node. The power indication indicates whether each incoming baseband symbol is a zero-power symbol or not. The method comprises providing a deactivation indication to deactivate the PIM cancellation from being performed for any zero-power symbol.

According to a second aspect there is presented a controller for symbol-based control of PIM cancellation in a network node. The controller comprises processing circuitry. The processing circuitry is configured to cause the controller to obtain a power indication per each incoming baseband symbol in the network node. The power indication indicates whether each incoming baseband symbol is a zero-power symbol or not. The processing circuitry is configured to cause the controller to provide a deactivation indication to deactivate the PIM cancellation from being performed for any zero-power symbol.

According to a third aspect there is presented a controller for symbol-based control of PIM cancellation in a network node. The controller comprises an obtain module configured to obtain a power indication per each incoming baseband symbol in the network node. The power indication indicates whether each incoming baseband symbol is a zero-power symbol or not. The controller comprises a provide module configured to provide a deactivation indication to deactivate the PIM cancellation from being performed for any zero-power symbol.

According to a fourth aspect there is presented a computer program for symbol-based control of PIM cancellation in a network node. The computer program comprises computer code which, when run on processing circuitry of a controller, causes the controller to perform actions. One action comprises the controller to obtain a power indication per each incoming baseband symbol in the network node. The power indication indicates whether each incoming baseband symbol is a zero-power symbol or not. One action comprises the controller to provide a deactivation indication to deactivate the PIM cancellation from being performed for any zero-power symbol.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient PIM cancellation without experiencing the issues disclosed above.

Advantageously, these aspects improve the PIM cancellation compared to the state-of-the-art. Compared to traditional approaches, efficient PIM cancellation can be achieved with a minimum increase in power consumption, size, and weight of the network node.

Advantageously, these aspects enable power in components of the PIM cancellation, such as filter chains, to be reduced.

Advantageously, the herein disclosed aspects can be provided in reusable blocks.

Advantageously, the herein disclosed aspects are easily integrated with existing PIM cancellation technologies.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a communication system according to embodiments;

FIG. 2 schematically illustrates a block diagram of a controller according to an embodiment;

FIG. 3 is a flowchart of methods according to embodiments;

FIG. 4 is a block diagram of a first filter chain example controller according to an embodiment;

FIG. 5 is a block diagram of a second filter chain example controller according to an embodiment;

FIG. 6 is a schematic diagram showing functional units of a controller according to an embodiment;

FIG. 7 is a schematic diagram showing functional modules of a controller according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

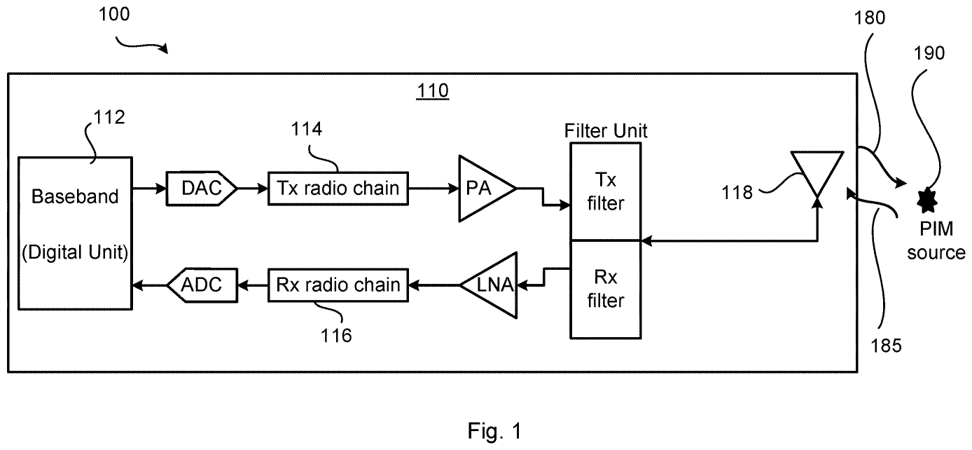

In FIG. 1 is shown a communication system 100 comprising a block diagram of a network node 110 and an external PIM source 190. The network node 110 comprises a (digital) baseband unit 112, a transmit radio chain 114 (along which is placed a digital to analogue (DAC) converter, a power amplifier (PA) and a transmit (Tx) filter), a receive radio chain 116 (along which is placed a receive (Rx) filter, a low noise amplifier (LNA), and an analogue to digital (ADC) converter), and an antenna system 118. As is understood, in this respect the network node 110 might comprise a plurality of transmit radio chains, a plurality of receive radio chains, and/or more than one antenna system. In FIG. 1 is further illustrated an external PIM source 190 that, when being impinged by a transmit signal 180 as transmitted by the transmit radio chain 114, causes PIM to a receive signal 185 to be passed on to the receive radio chain 116 from the antenna system 118. In this respect, there could be different causes of the PIM. In some examples, as in FIG. 1, the PIM is caused by a PIM source 190 external to the network node 110. Such a PIM source is referred to as an external PIM source. In other examples, the PIM is caused by an electric component, such as a passive electric component, in the network node 110, for example in the transmit radio chain 114. Such a PIM source is referred to as an internal PIM source. In some examples, there is both an external PIM source and an internal PIM source. In some examples, there is more than one external PIM source and/or more than one internal PIM source.

As disclosed above, there is still a need for improved PIM cancellation.

The embodiments disclosed herein therefore relate to techniques for symbol-based control of PIM cancellation in a network node 110. In order to obtain such techniques, there is provided a controller 600, 700, a method performed by the controller 600, 700, a computer program product comprising code, for example in the form of a computer program, that when run on a controller 600, 700, causes the controller 600, 700 to perform the method.

The embodiments disclosed herein make use of power information of incoming baseband symbol, and particularly indications that incoming baseband symbols have zero power. When such indications are received, the PIM cancellation can be automatically switched off related to that symbol, implying that PIM cancellation is not performed for the symbol. This enables the PIM cancellation to be switched off when not needed. In turn, this reduces the power consumption of the PIM cancellation, thereby reducing the requirements for cooling.

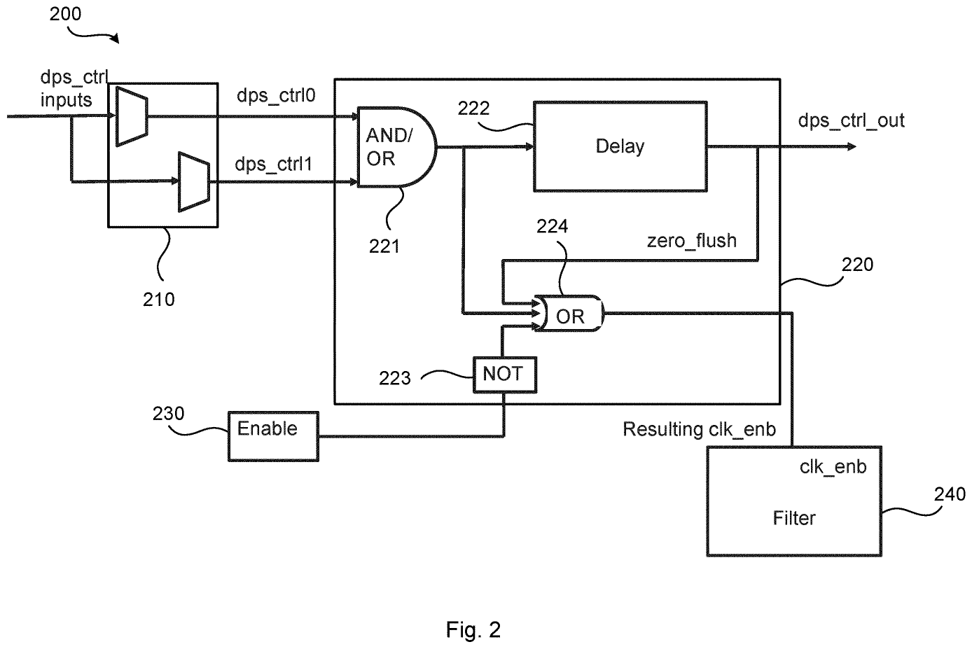

Reference is next made to the block diagram 200 according to FIG. 2. In FIG. 2 is illustrated a controller 220 for symbol-based control of PIM cancellation in the network node. The controller 220 takes as input one power indication per each incoming baseband symbol to the network node. In the block diagram 200 it is assumed that there are two such inputs, dps_ctrl0 and dps_ctrl1 stemming from a joint combination of power indicators, as represented by dps_ctrl inputs, for the baseband symbols. In the specific example, there are incoming indicators of zero-power symbols from two different carriers (typical multiplier application). These two incoming signals carry 1 bit each and will have the value “0” when the symbol power is zero, otherwise “1”. Typically these 1-bit signals are provided from baseband power measurements, indicating when the power is zero. The controller 220 is configured to output a 1-bit signal, clk_enb, that is provided to deactivate the PIM cancellation, as in FIG. 2 represented by a filter 240. In order to do so, the inputs, dps_ctrl0 and dps_ctrl1 are first in logic block 221 combined either by a logic AND function or a logic OR function. The output of the logic block 221 served two purposes. First, in some embodiments, two or more controllers 220 are cascaded. The output of the logic block 221 is therefore delayed, in a delay block 222, before being output, dps_ctrl_out, where this output can be used as input to another controller 220. Second, the output, denoted zero_flush, of the logic block 221 is combined with the output of the delay block 222 and a negated enable signal 230 in a logic OR block 224. The enable signal determines whether the functionality provided by the controller 220 should be used or not. The signal zero_flush will fill up (flush) the internal pipeline of the controller 220 with incoming data right after the dps_ctrl signal goes to ‘0’. Typically the incoming data is zero when the dps_ctrl signal is ‘0’. Zero data in pipelines typically use less power when the clock is turned off compared to non-zero data. Typically, the incoming data is zero when dps_ctrl is ‘0’. Hence the controller 220 block fills the internal pipeline with incoming data right after the dps_ctrl signal goes to ‘0’. This is implemented by combining the outgoing dps_ctrl signal (after the internal delay as caused by the delay block 222) with the incoming dps_ctrl signal in the logic OR block 224. When the output from the logic OR block 224 is zero, the PIM cancellation is deactivated.

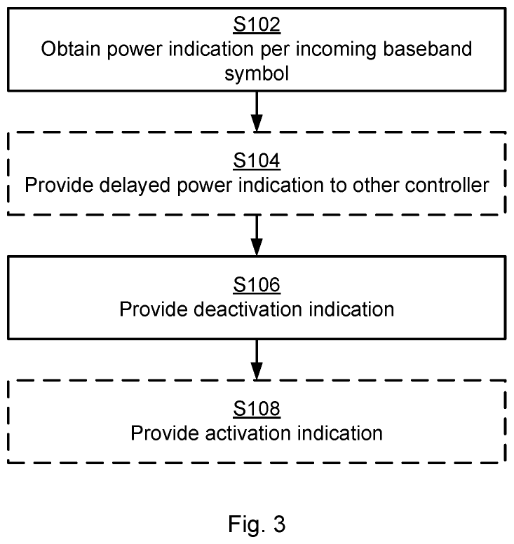

FIG. 3 is a flowchart illustrating embodiments of methods for symbol-based control of PIM cancellation in the network node 110 as performed by the controller 220, 600, 700. The methods are advantageously provided as computer programs 820.

S102: The controller 220, 600, 700 obtains a power indication per each incoming baseband symbol in the network node 110. The power indication indicates whether each incoming baseband symbol is a zero-power symbol or not.

As disclosed above, the PIM cancellation can be automatically switched off related to symbols with zero power.

S106: The controller 220, 600, 700 provides a deactivation indication to deactivate the PIM cancellation from being performed for any zero-power symbol.

Embodiments relating to further details of symbol-based control of PIM cancellation in a network node 110 as performed by the controller 220, 600, 700 will now be disclosed with continued reference to FIG. 3.

In some aspects, the PIM cancellation is explicitly enabled, or activated, for baseband symbols that are not zero-power symbols. Hence, in some embodiments, the controller 220, 600, 700 is configured to perform (optional) step S108.

S108: The controller 220, 600, 700 provides an activation indication to keep the PIM cancellation activated for any incoming baseband symbol not being a zero-power symbol.

There could be different types of power indicators. The parameters dps_cttrl0 and dps_ctrl1 that are fed to the logic block 221 in FIG. 2 represent one example of such a power indicator. This power indicator is an example of a one-bit signal. In particular, in some embodiments, the power indication per each incoming baseband symbol is a one-bit signal and is obtained from baseband power measurements.

In general terms, there can be one or more such power indicators, for example from one, or two, or more different carriers. That is, in some embodiments, there are, per symbol time, at least two incoming baseband symbols, each with its own power indication. The deactivation indication per symbol time can then be determined from a combination of the power indications for the at least two incoming baseband symbols. The controller 220, 600, 700 is thereby configured to handle multiple inputs.

In case there are two or more inputs, there could be different ways in how these inputs are combined (e.g., so as to provide a one-bit input to the delay block 222 and the logic OR block 224). In general terms, and as will be disclosed next, how to combine the inputs depend on the relation between the carriers. For example, either a logic AND function or a logic OR function can be used, as in logic block 221, to aggregate multiple inputs, corresponding to power save in blocks of multiplier type (AND) or adder type (OR).

In some embodiments, the combination is a logic AND operation (and hence logic block 221 implements a logic AND function) over the power indications for the at least two incoming baseband symbols in case the at least two incoming baseband symbols either are to be, or have been, multiplied with each other prior to transmission.

In some embodiments, the combination is a logic OR operation (and hence logic block 221 implements a logic OR function) over the power indications for the at least two incoming baseband symbols in case the at least two incoming baseband symbols either are to be, or have been, added to each other prior to transmission.

There could be different types of PIM cancellation techniques. In some examples, the PIM cancellation involves utilizing at least one filter chain, and the deactivation indication is provided to deactivate the at least one filter chain from processing the zero-power symbol. Further, in some examples, the PIM cancellation involves utilizing at least one clock, and the deactivation indication is provided to turn off the at least one clock during the duration of the zero-power symbol.

As noted above, in some embodiments, two or more controllers 220, 600, 700 are cascaded. The output of one controller 220, 600, 700 could then be used as input to another controller 220, 600, 700. In particular, in some embodiments, the PIM cancellation is performed in a sequence of daisy-chained PIM cancellation blocks, where the controller 220, 600, 700 is configured for symbol-based control of PIM cancellation in one of the PIM cancellation blocks. Assuming that the controller 220, 600, 700 is configured for symbol-based control of PIM cancellation in a first PIM cancellation block, then in some embodiments, the controller 220, 600, 700 is configured to perform (optional) step S104.

S104: The controller 200 provides the power indication as delayed (e.g., the above denoted signal dps_ctrl_out) as input to another controller 220, 600, 700, where this another controller 220, 600, 700 is configured for symbol-based control of PIM cancellation in a second PIM cancellation blocks that is adjoining the first PIM cancellation block. The power indication is provided with the same delay as the data processing delay between the first PIM cancellation block and the second PIM cancellation block.

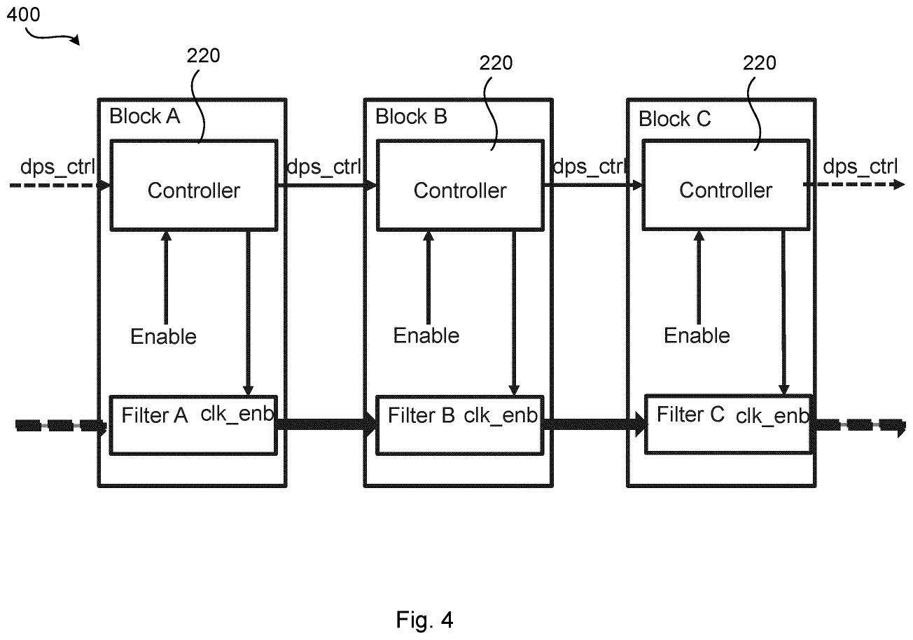

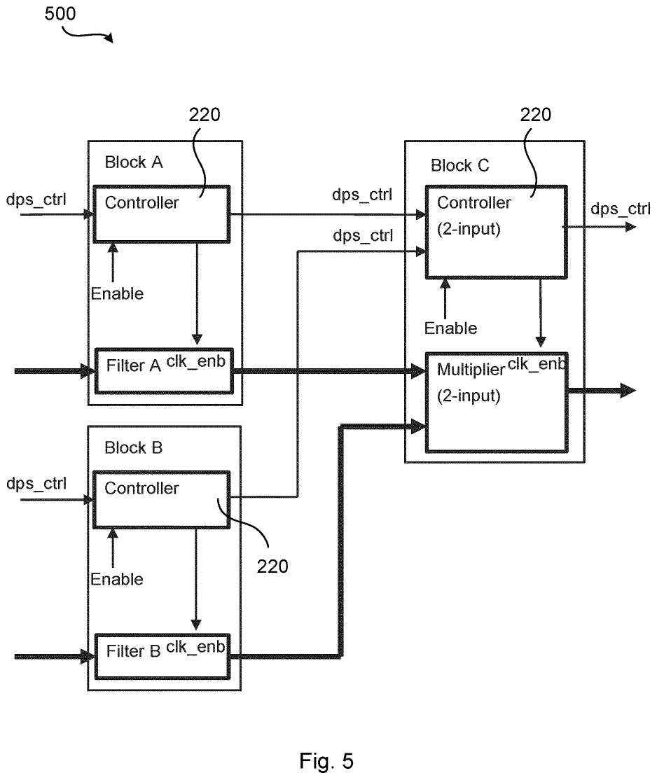

Intermediate reference is here made to the examples in FIG. 4 and FIG. 5.

In FIG. 4 is illustrated a block diagram 400 of a first filter chain example. Three controllers 220, 600, 700 have been cascaded. One occurrence of the controller 220, 600, 700 is instantiated in each of the three PIM cancellation blocks (denoted Block A, Block B, and Block C) of the filter chain (composed of Filter A, Filter B, and Filter C) as utilized in the PIM cancellation. The above denoted signal dps_ctrl_out is here simply denoted dps_ctrl and is thus delayed and daisy-chained parallel to the data, keeping the same delay as the data. This ensures that the filters (and other blocks) as utilized in the PIM cancellation are turned off at exactly the same time as when a symbol with zero power is to be processed by the block.

In FIG. 5 is illustrated a block diagram 500 of a second filter chain example. The second filter chain example is similar to the first filter chain example in FIG. 4 but with the following differences. Firstly, the two PIM cancellation blocks denoted Block A and Block B are arranged in parallel. Secondly, Block C takes as input the outputs as provided by both Block A and Block B. In other words, the controller 220, 600, 700 of Block C, as well as the PIM cancellation (as represented by a multiplier) of Block C have two inputs.

In general terms, the incoming baseband symbols could be part of either downlink signals or uplink signals. Thus, in some embodiments, the incoming baseband symbol is to be included in a downlink signal to be wirelessly transmitted from the network node 110, whereas in other embodiments, the incoming baseband symbol is extracted from an uplink signal as wirelessly received by the network node 110.

Different aspects relating thereto will be disclosed next, starting with the downlink, and then continuing with the uplink.

For the downlink, it is assumed that transmission of a downlink signal infers PIM on the uplink receiver. The downlink zero-power inputs (notated as “dps_ctrl”) can then be directly used by the controller 220, 600, 700 to execute any of the herein disclosed embodiments. This could, for example, be the case where it can be identified from the wire connections inside the network node 110 which downlink aggregators that belong to which uplink receiver.

For the uplink, knowledge of which parts of the downlink filter chain that belong to which uplink filter chain can be used. This knowledge can be realized through a table comprising information of downlink filter chain resources and which uplink filter chain resources they belong to. In some examples, such a table is realized by containing one row per receive antenna branch. The mapping could also be realized the other way around, where each resource is represented by a row with one bit per receive antenna branch. Each row will then contain one bit per resource. The granularity in a resource-row will exactly match clk_enable register granularity for all possible resources.

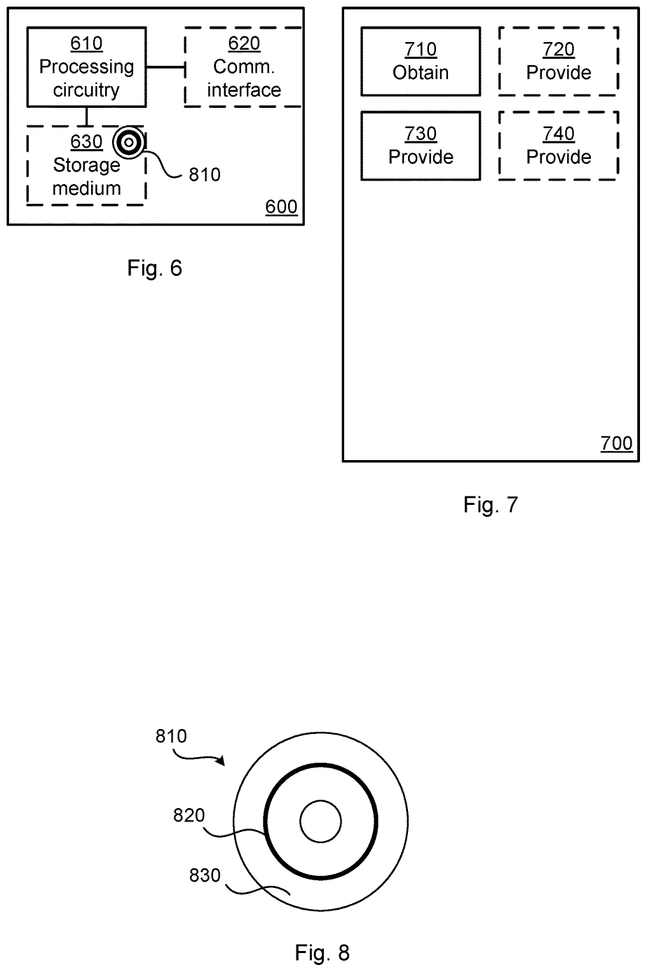

FIG. 6 schematically illustrates, in terms of a number of functional units, the components of a controller 600 according to an embodiment. Processing circuitry 610 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 630. The processing circuitry 610 may further be provided as at least one ASIC, or field programmable gate array (FPGA).

Particularly, the processing circuitry 610 is configured to cause the controller 600 to perform a set of operations, or steps, as disclosed above. For example, the storage medium 630 may store the set of operations, and the processing circuitry 610 may be configured to retrieve the set of operations from the storage medium 630 to cause the controller 600 to perform the set of operations. The set of operations may be provided as a set of executable instructions.

Thus the processing circuitry 610 is thereby arranged to execute methods as herein disclosed. The storage medium 630 may also comprise persistent storage, which, for example, can be any single one or combination of magnetic memory, optical memory, solid state memory or even remotely mounted memory. The controller 600 may further comprise a communications (comm.) interface 620. As such the communications interface 620 may comprise one or more transmitters and receivers, comprising analogue and digital components. The processing circuitry 610 controls the general operation of the controller 600 e.g. by sending data and control signals to the communications interface 620 and the storage medium 630, by receiving data and reports from the communications interface 620, and by retrieving data and instructions from the storage medium 630. Other components, as well as the related functionality, of the controller 600 are omitted in order not to obscure the concepts presented herein.

FIG. 7 schematically illustrates, in terms of a number of functional modules, the components of a controller 700 according to an embodiment. The controller 700 of FIG. 7 comprises a number of functional modules; an obtain module 710 configured to perform step S102, and a provide module 730 configured to perform step S106. The controller 700 of FIG. 7 may further comprise a number of optional functional modules, such as any of a provide module 720 configured to perform step S104, and a provide module 740 configured to perform step S108. In general terms, each functional module 710:740 may in one embodiment be implemented only in hardware and in another embodiment with the help of software, i.e., the latter embodiment having computer program instructions stored on the storage medium 630 which when run on the processing circuitry makes the controller 600, 700 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 710:740 may be implemented by the processing circuitry 610, possibly in cooperation with the communications interface 620 and/or the storage medium 630. The processing circuitry 610 may thus be configured to from the storage medium 630 fetch instructions as provided by a functional module 710:740 and to execute these instructions, thereby performing any steps as disclosed herein.

The controller 600, 700 may be provided as a standalone device or as a part of at least one further device. For example, the controller 600, 700 may be provided in a node of the radio access network and might be part of, integrated with, or collocated with, the network node 110. Alternatively, functionality of the controller 600, 700 may be distributed between at least two devices, or nodes. Thus, a first portion of the instructions performed by the controller 600, 700 may be executed in a first device, and a second portion of the of the instructions performed by the controller 600, 700 may be executed in a second device; the herein disclosed embodiments are not limited to any particular number of devices on which the instructions performed by the controller 600, 700 may be executed. Hence, the methods according to the herein disclosed embodiments are suitable to be performed by a controller 600, 700 residing in a cloud computational environment. Therefore, although a single processing circuitry 610 is illustrated in FIG. 6 the processing circuitry 610 may be distributed among a plurality of devices, or nodes. The same applies to the functional modules 710:740 of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 610 and thereto operatively coupled entities and devices, such as the communications interface 620 and the storage medium 630, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-19. (canceled)

20. A method for symbol-based control of passive intermodulation (PIM) cancellation in a network node, the method being performed by a controller, the method comprising:
for each incoming baseband symbol, obtaining a power indication that indicates whether the incoming baseband symbol is a zero-power symbol; and
for each incoming baseband symbol indicated to be a zero-power symbol, providing a deactivation indication to deactivate the PIM cancellation from being performed for the incoming baseband symbol.

21. The method according to claim 20, wherein the method further comprises for each incoming baseband symbol indicated not to be a zero-power symbol, providing an activation indication to keep the PIM cancellation activated for the incoming baseband symbol.

22. The method according to claim 20, wherein the power indication for each incoming baseband symbol is a one-bit signal and is obtained from baseband power measurements.

23. The method according to claim 20, wherein there are at least two incoming baseband symbols during each symbol time, each deactivation indication is associated with a corresponding symbol time and is determined based on a combination of the at least two power indications for the respective at least two incoming baseband symbols during the corresponding symbol time.

24. The method according to claim 23, wherein when the at least two incoming baseband symbols during a symbol time are to be or have been multiplied with each other prior to transmission, the combination is a logical AND operation over the at least two power indications for the respective at least two incoming baseband symbols.

25. The method according to claim 23, wherein when the at least two incoming baseband symbols during a symbol time are to be or have been added with each other prior to transmission, the combination is a logical OR operation over the at least two power indications for the respective at least two incoming baseband symbols.

26. The method according to claim 20, wherein the PIM cancellation utilizes at least one filter chain, and the deactivation indication deactivates the at least one filter chain from processing each incoming baseband symbol indicated to be a zero-power symbol.

27. The method according to claim 20, wherein the PIM cancellation utilizes at least one clock, and the deactivation indication turn offs the at least one clock for a duration of each incoming baseband symbol indicated to be a zero-power symbol.

28. The method according to claim 20, wherein the PIM cancellation is performed in a sequence of daisy-chained PIM cancellation blocks, and the controller is configured for symbol-based control of PIM cancellation in a first one of the PIM cancellation blocks.

29. The method according to claim 28, wherein:
the first PIM cancellation blocks is an initial one of the PIM cancellation blocks;
the method further comprises, for each incoming baseband symbol, providing the power indication as input to another controller configured for symbol-based control of PIM cancellation in a second one of the PIM cancellation blocks adjoining the first PIM cancellation block, and
the power indication is provided as input to the other controller with a delay that corresponds to a data processing delay between the first PIM cancellation block and the second PIM cancellation block.

30. The method according to claim 20, wherein each incoming baseband symbol is to be included in a corresponding downlink signal to be wirelessly transmitted from the network node.

31. The method according to claim 20, wherein each incoming baseband symbol is extracted from a corresponding uplink signal wirelessly received by the network node.

32. A controller configured to facilitate symbol-based control of passive intermodulation (PIM) cancellation in a network node, the controller comprising processing circuitry configured to cause the controller to:
for each incoming baseband symbol, obtain a power indication that indicates whether the incoming baseband symbol is a zero-power symbol; and
for each incoming baseband symbol indicated to be a zero-power symbol, provide a deactivation indication to deactivate the PIM cancellation from being performed for the incoming baseband symbol.

33. The controller according to claim 32, wherein the processing circuitry is further configured to cause the controller to, for each incoming baseband symbol indicated not to be a zero-power symbol, provide an activation indication to keep the PIM cancellation activated for the incoming baseband symbol.

34. The controller according to claim 32, wherein the power indication for each incoming baseband symbol is a one-bit signal and is obtained from baseband power measurements.

35. The controller according to claim 32, wherein there are at least two incoming baseband symbols during each symbol time, each deactivation indication is associated with a corresponding symbol time and is determined based on a combination of the at least two power indications for the respective at least two incoming baseband symbols during the corresponding symbol time.

36. The controller according to claim 35, wherein when the at least two incoming baseband symbols during a symbol time are to be or have been multiplied with each other prior to transmission, the combination is a logical AND operation over the at least two power indications for the respective at least two incoming baseband symbols.

37. The controller according to claim 35, wherein when the at least two incoming baseband symbols during a symbol time are to be or have been added with each other prior to transmission, the combination is a logical OR operation over the at least two power indications for the respective at least two incoming baseband symbols.

38. The controller according to claim 32, wherein one or more of the following applies:
the PIM cancellation utilizes at least one filter chain, and the deactivation indication deactivates the at least one filter chain from processing each incoming baseband symbol indicated to be a zero-power symbol; and
the PIM cancellation utilizes at least one clock, and the deactivation indication turn offs the at least one clock for a duration of each incoming baseband symbol indicated to be a zero-power symbol.

39. Non-transitory, computer-readable medium storing computer-executable instructions that, when executed by processing circuitry of a controller configured to facilitate symbol-based control of passive intermodulation (PIM) cancellation, cause the controller to:
for each incoming baseband symbol, obtain a power indication that indicates whether the incoming baseband symbol is a zero-power symbol; and
for each incoming baseband symbol indicated to be a zero-power symbol, provide a deactivation indication to deactivate the PIM cancellation from being performed for the incoming baseband symbol.
